(19) United States
(12) Patent Application Publication
(10) Pub. No.: US 2005/0235568 A1
(43) Pub. Date: Oct. 27, 2005

(54) Anti-rattle device for a pocket door assembly

(76) Inventors: Fred E. Holmstrom, Janesville, CA (US); Sherry A. Holmstrom, Janesville, CA (US)

Correspondence Address: RADER, FISHMAN & GARAUER PLLC, 10653 SOUTH RIVER FRONT PARKWAY, SUITE 150, SOUTH JORDAN, UT, 84095, US

(21) Appl. No.: 10/832,180

(22) Filed: Apr. 26, 2004

(51) Int. Cl. E05F 11/38

(52) U.S. Cl. 49/372

(57) ABSTRACT

The present invention relates in general to a pocket door assembly having an anti-rattle device. More particularly, the present invention provides anti-rattle devices for minimizing noise created by movement of a pocket door in the pocket door assembly. The present invention also relates to a method for installing the anti-rattle device in the pocket door assembly. An exemplary pocket door assembly can include a door jamb configured to stop a pocket door at a closed position and at least one anti-rattle device coupled to the door jamb, in which the anti-rattle device is configured to fittingly receive the pocket door at the closed position.

### BACKGROUND

A pocket door is a door that slides in and out of a recess or pocket in a wall, rather than swinging on hinges between an open position and a closed position. Pocket doors are often used for closing off a room, such as a room of a house. Pocket doors can be especially useful in compact areas where space constraints may prevent use of a typical swinging door. Pocket doors are typically designed to slide along a vertical plane. When in the “open” position, a pocket door typically is stowed within a pocket of an adjacent wall. This helps minimize the amount of space in a room that is occupied by pocket doors.

To facilitate the sliding of the pocket doors between the “open” and the “closed” positions, pocket doors are typically mounted on a track by some type of low-friction mechanism, such as a runner. The runner allows the pocket doors to be freely moved across the track. Guide mechanisms may be positioned along the track or the runner to help guide the pocket door along the track. Similar to the runner, the guide mechanisms should not create undesirable friction with the pocket door. Accordingly, the guide mechanisms and tracks are typically spaced a certain distance away from the pocket door to avoid causing friction with the pocket door.

While typical pocket doors are useful and convenient, they often tend to create unwanted noises. In particular, pocket doors are prone to rattle. This is typically due to the design of pocket door assemblies. For example, to maintain low friction levels that are conducive to the convenient sliding of pocket doors, the pocket doors are typically connected to pocket door assemblies by low-friction mechanisms, such as the runners, as mentioned above. Often, the low-friction mechanisms are the only connection between the pocket doors and the pocket door assemblies. While this allows the pocket door to slide easily along the track, the pocket door is free to shift back and forth. As the pocket door shifts on its track, e.g., back and forth between guide mechanisms or edges of the wall pocket, rattling noises tend to be generated.

The rattling noises can be induced by any force, such as human contact, wind, or the shifting of a building's walls. For example, a wind may cause the walls of a building to shift. In response, a pocket door within the building can shift within its track or guide mechanisms, thereby generating a rattling noise. The rattling noise is often generated as the shifting pocket door contacts its guide mechanisms.

The rattling noises can be especially problematic when pocket doors are in the “closed” position. For example, when in the “closed” position, a pocket door is almost fully exposed to forces caused by winds or drafts traveling through a building. The drafts often cause the pocket door to vibrate, and consequently, generate a rattling noise. This problem is magnified when windows or doors of a building are open to the outside atmosphere.

### SUMMARY

The present invention relates in general to a pocket door assembly having one or more anti-rattle devices. More particularly, the present invention provides anti-rattle devices for minimizing noise caused by movement of a pocket door in the pocket door assembly. The present invention also relates to a method for installing the anti-rattle device in the pocket door assembly.

An exemplary pocket door assembly can include a door jamb configured to stop a pocket door at a closed position and at least one anti-rattle device coupled to the door jamb, in which the anti-rattle device is configured to fittingly receive the pocket door at the closed position.

Another exemplary pocket door assembly can include at least one anti-rattle device positioned at a back region of a wall pocket, wherein the anti-rattle device is configured to fittingly receive a pocket door at an open position. The anti-rattle device should be configured to help prevent the pocket door from generating rattling noises.

Another exemplary pocket door assembly can include a pocket door, a door jamb configured to stop the pocket door at a closed position, a first anti-rattle device coupled to the doorjamb, and a second anti-rattle device coupled to the pocket door opposite from the first anti-rattle device, wherein the first anti-rattle device and the second anti-rattle device are configured to couple together when the pocket door is at the closed position. The first and second anti-rattle devices may include magnets.

Another exemplary pocket door assembly can include a pocket door having a magnetic material, a door jamb configured to stop the pocket door at a closed position, and at least one magnetic anti-rattle device coupled to the door jamb, wherein the at least one magnetic anti-rattle device is configured to couple to the pocket door when the pocket door is at the closed position.

An exemplary method of installing an anti-rattle device on a door jamb of a pocket door assembly can include: inserting fixation mechanisms into connection apertures of said anti-rattle device; placing the anti-rattle device fittingly on a pocket door of the pocket door assembly; moving the pocket door until the fixation mechanisms mark positions on the door jamb; and securing the anti-rattle device to the door jamb at the marked positions.

### BRIEF DESCRIPTION OF THE DRAWINGS

The accompanying drawings illustrate various embodiments of the present invention and are a part of the specification. Together with the following description, the drawings demonstrate and explain principles of the present invention. The illustrated embodiments are merely examples of the present invention and do not limit the scope of the invention.

FIG. 1 illustrates an exemplary embodiment of a pocket door assembly with a number of anti-rattle devices having received a pocket door at a “closed” position.

FIG. 2 illustrates the pocket door assembly of FIG. 1 with the pocket door in an unclosed position.

FIG. 3 is a top-view of another pocket door assembly with an anti-rattle device having received a pocket door at an “open” position.

FIG. 4 is another embodiment of a pocket door assembly having a number of alternative anti-rattle devices.

FIG. 5A is a perspective view of yet another embodiment of a pocket door assembly having a number of other alternative anti-rattle devices.

FIG. 5B is a different perspective view of the pocket door assembly of FIG. 5A.

FIG. 6 is a perspective view of an exemplary embodiment of an anti-rattle device.

FIG. 7 is a top-view of the anti-rattle device of FIG. 6.

FIG. 8 is a front-view of the anti-rattle device of FIG. 6.

FIG. 9 is an exemplary embodiment of an anti-rattle device having guide members.

FIG. 10 is a flow diagram illustrating an exemplary process for installing an anti-rattle device in a pocket door assembly.

### DETAILED DESCRIPTION

The present invention relates in general to a pocket door assembly having one or more anti-rattle devices. More particularly, the present invention provides anti-rattle devices for minimizing noise caused by movement of a pocket door in the pocket door assembly. The present invention also relates to a method for installing the anti-rattle device in the pocket door assembly.

In the following description, for purposes of explanation, numerous specific details are set forth in order to provide a thorough understanding of the present pocket door assemblies, anti-rattle devices, and methods for installing the anti-rattle devices in the pocket door assemblies. It will be apparent, however, to one skilled in the art that the present assemblies, devices, and methods may be practiced without these specific details. For example, while the examples disclosed below generally relate to pocket doors, it is anticipated that the anti-rattle device may be used with many types of sliding door assemblies, including but not limited to a sliding cabinet door and a sliding door that is stowed external to an adjacent wall.

Reference in the specification to “one embodiment,” “an embodiment,” or “an exemplary embodiment” means that a particular feature, structure, or characteristic described in connection with the embodiment is included in at least one embodiment. The phrases “in one embodiment” and “in an exemplary embodiment” appear in various places in the specification and are not necessarily all referring to the same embodiment.

Exemplary Pocket Door Assemblies

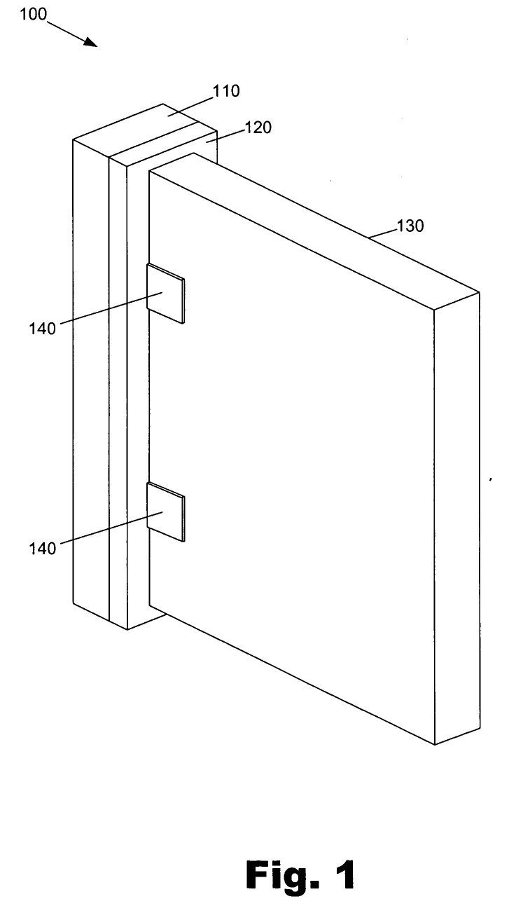

Referring now to the drawings, FIG. 1 is a perspective view of an exemplary pocket door assembly (100) that includes a wall (110), a door jamb (120) coupled to the wall (110), a pocket door (130), and a number of anti-rattle devices (140) coupled to the doorjamb (120). In FIG. 1, the pocket door (130) is at a “closed” position. At the “closed” position, the pocket door (130) closes off a doorway. In addition, at the “closed” position, the pocket door (130) is fittingly received by the anti-rattle devices (140).

The wall (110) can be any wall that is adjacent to the pocket door (130), such as any wall that is part of the frame for the pocket door assembly (100). For example, the wall (110) may include any wall configured to help stop the pocket door (130) at the “closed” position. Preferably, the wall (110) is transversely oriented to a plane along which the pocket door (130) is configured to slide. For example, the wall (110) may comprise a generally vertical wall that is positioned to help stop the pocket door (130) at the “closed” position.

As shown in FIG. 1, the doorjamb (120) can be coupled to the wall (110). The doorjamb (120) should generally frame the pocket door assembly (100). Thus, the doorjamb (120) can comprise any frame material adjacent to the pocket door (130). In FIG. 1, the door jamb (120) is represented by a generally vertical portion of the doorjamb (120) positioned to help stop the pocket door (130) at the “closed” position.

The pocket door (130) can comprise any door that is configured to slide along a generally vertical plane. For example, the pocket door (130) may be configured to slide along the generally vertical plane defined by the pocket door (130). Any mechanism known in the art can be used to facilitate the sliding of the pocket door (130) within the pocket door assembly (100). For example, although not shown in FIG. 1, the top edge and/or the bottom edge of the pocket door (130) can be connected to a sliding mechanism. The sliding mechanism can include a track and a number of runners. Accordingly, the pocket door (130) can slide along the track. Further, the sliding mechanism may include guides to help prevent the pocket door (130) from leaving the track.

The pocket door (130) should be configured to slide between the “closed” position and an “open” position. In FIG. 1, the pocket door (130) is shown at the “closed” position. When in the “closed” position, the pocket door (130) is received by the anti-rattle devices (140). By fittingly receiving the pocket door (130), the anti-rattle devices (140) help prevent the “closed” pocket door (130) from shifting or vibrating. This helps minimize any rattle noises that can be created by the pocket door (130). Some exemplary embodiments of the anti-rattle devices (140) will be discussed below.

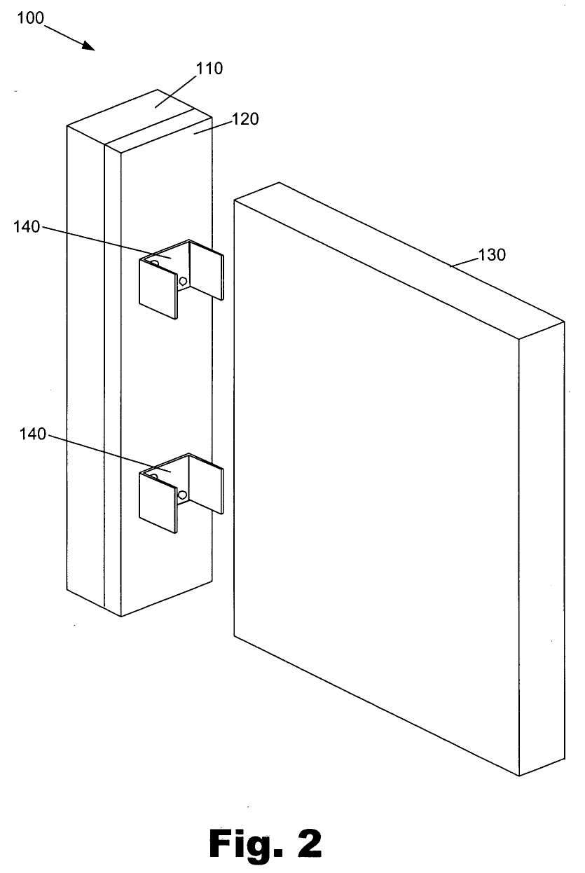

FIG. 2 shows a perspective view of the pocket door assembly (100) of FIG. 1 with the pocket door (130) in an “unclosed” position. In the “unclosed” position, the pocket door (130) is not secured by the anti-rattle devices (140). This allows the pocket door (130) to slide freely between the “closed” and the “open” positions.

The anti-rattle devices (140) should be positioned along the door jamb (120) or the wall (110) at appropriate positions that effectively help reduce any shifting of the pocket door (130). For example, a first anti-rattle device (140) can be positioned toward the top of the doorjamb (120) while a second anti-rattle device (140) can be positioned toward the bottom of the doorjamb (120). Any number of anti-rattle devices (140) can be used to minimize noise created by the shifting of the pocket door (130).

The anti-rattle devices (140) should also be positioned to avoid or otherwise minimize inconvenience. For example, the anti-rattle device (140) can be positioned toward the top of the door jamb (120) at a height that is unlikely to cause inconvenience. Further, the anti-rattle device (140) can comprise a size that minimizes its protrusion into a doorway.

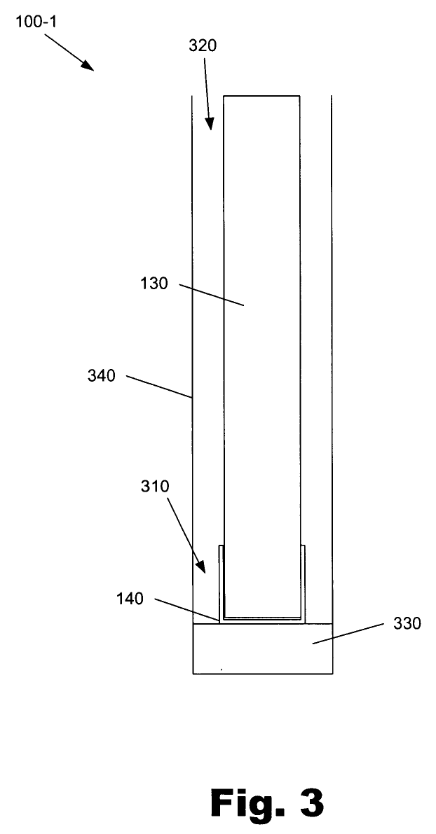

While FIG. 1 shows the anti-rattle devices (140) having received the pocket door (130) at the “closed” position, it is anticipated that the anti-rattle devices (140) can be configured to receive and minimize shifting of the pocket door (130) at the “open” position. At the “open” position, the pocket door (130) should be stowed within a recess of a wall configured to house the pocket door (130). For example, FIG. 3 shows a top-view of a pocket door assembly (100-1), in which at least one anti-rattle device (140) is positioned to receive the pocket door (130) at the “open” position. As shown in FIG. 3, the anti-rattle device (140) can be positioned at a back region (310) of a wall pocket (320) of a pocket door assembly (100-1). In particular, the anti-rattle device (140) can be secured to the wall (110), a stud (330), drywall (340), or other framing material at the back of the wall pocket (320). This allows the anti-rattle device (140) to receive and fittingly secure the pocket door (130) at the “open” position.

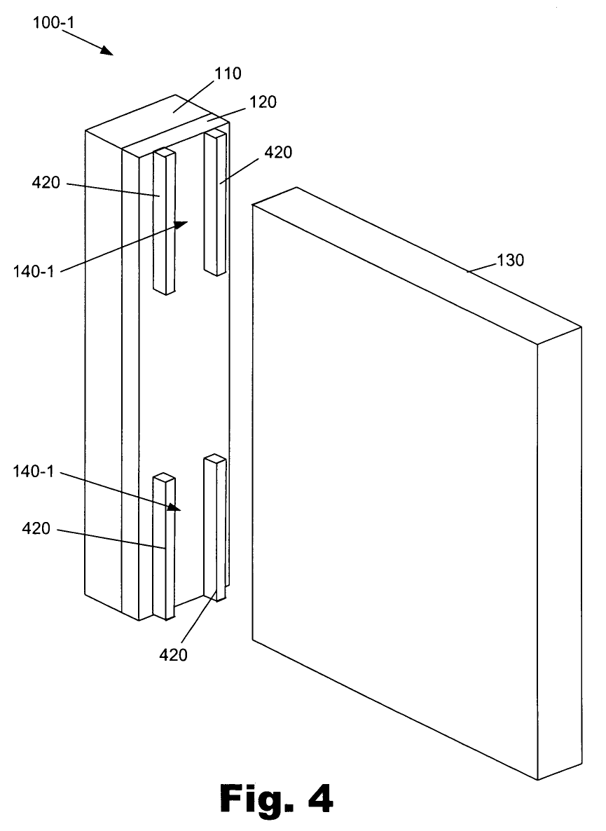

FIG. 4 is another embodiment of a pocket door assembly (100-1) having a number of alternative embodiments of anti-rattle devices (140-1). The anti-rattle devices (140-1) are configured to receive the pocket door (130) when the pocket door (130) is moved to the “closed” position.

The anti-rattle device (140-1) of FIG. 4 comprises a pair of oppositely positioned friction ledges (420) protruding away from the door jamb (120) and separated by a predefined distance. The predefined distance should correspond approximately with the width of the pocket door (130) so that the pair of ledges (420) can fittingly receive the pocket door (130) at the “closed position.” Although not shown in FIG. 4, the ledges (420) can include tapered portions configured to guide the pocket door (130) into a fittingly received position.

The ledges (420) can comprise virtually any material that can be connected to the doorjamb (120). In a preferred embodiment, the ledges (420) comprise a wood material. The ledges (420) can be connected to the doorjamb (420) in a wide variety of ways, including but not limited to glue as well as fastening devices such as screws, staples, brackets, and nails.

While FIG. 4 shows two anti-rattle devices (140-1) connected to an upper portion and a lower portion of the door jamb (120), any number of the anti-rattle devices (140-1) of various lengths can be used in the pocket door assembly (100-1). For example, the pocket door assembly (100-1) can include a single anti-rattle device (140-1) that may extend along approximately the height of the door jamb (120). Further, it is anticipated that the anti-rattle devices (140-1) can be placed at a back region of the pocket door assembly (100-1) in any of the ways discussed above in relation to FIG. 3.

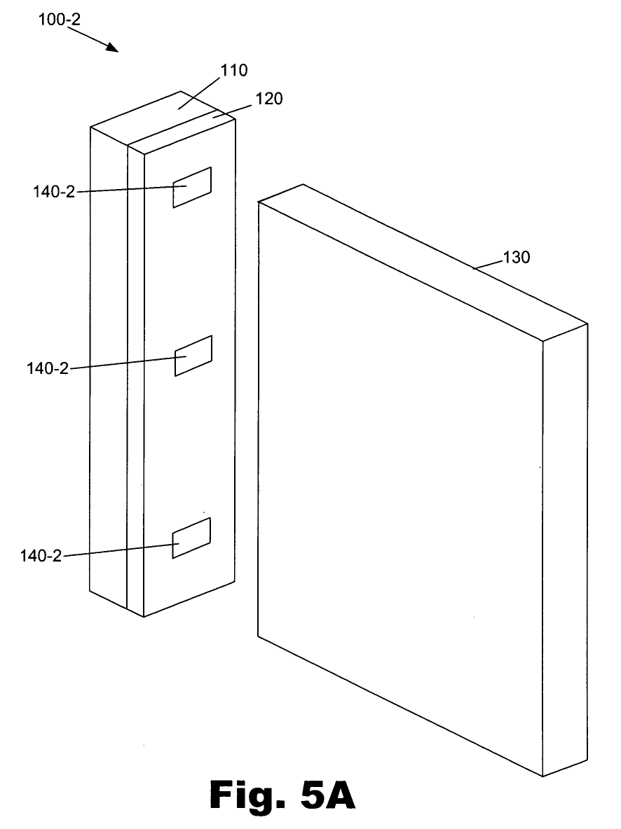

FIGS. 5A-B are perspective views of another embodiment of a pocket door assembly (100-2) having a number of alternative embodiments of anti-rattle devices (140-2). As shown in the figures, the anti-rattle devices (140-2) can be coupled to the door jamb (120), while additional anti-rattle devices (140-2) can be coupled to the pocket door (130) opposite from the anti-rattle devices (140-2) on the doorjamb (120). By being positioned opposite of each other, the anti-rattle devices (140-2) are configured to couple together when the pocket door (130) is moved to the “closed” position.

The anti-rattle devices (140-2) may comprise any structures that can couple together when in contact with each other. In a preferred embodiment, the anti-rattle devices (140-2) include magnets configured to securely couple together when the pocket door (130) is in the “closed” position. This coupling helps to minimize any rattle noises that may otherwise be created by an unsecured pocket door.

The anti-rattle devices (140-2) can be coupled to the doorjamb (120) and the pocket door (130) in a wide variety of ways, including but not limited to nails, screws, tape, staples, brackets, tacks, etc. In a preferred embodiment, the anti-rattle devices (140-2) comprise magnets, e.g., magnetic strips, which are adhesively coupled to the door jamb (120) and the pocket door (130).

While FIGS. 5A-B show three anti-rattle devices (140-2) connected to the doorjamb (120) and three anti-rattle devices (140-2) oppositely coupled to the pocket door (130), any number of the anti-rattle devices (140-2) of various sizes can be used in the pocket door assembly (100-2). For example, the pocket door assembly (100-2) can include a single anti-rattle device (140-2) coupled to the doorjamb (120) and a single anti-rattle device (140-2) oppositely coupled to the pocket door (130). Further, it is anticipated that the anti-rattle devices (140-2) can be placed at a back region of the pocket door assembly (100-2) in any of the ways discussed above in relation to FIG. 3.

In an embodiment where the pocket door (120) comprises a magnetic material, anti-rattle devices (140-2) can be coupled to the doorjamb (120) but not to the pocket door (130). When the magnetic pocket door (130) is at the “closed” position, the anti-rattle devices (140-2) at the doorjamb (120) magnetically couple to the pocket door (130), thereby securing the pocket door (130) to the door jamb (120) so that rattle noises will be minimized.

Exemplary Anti-Rattle Devices

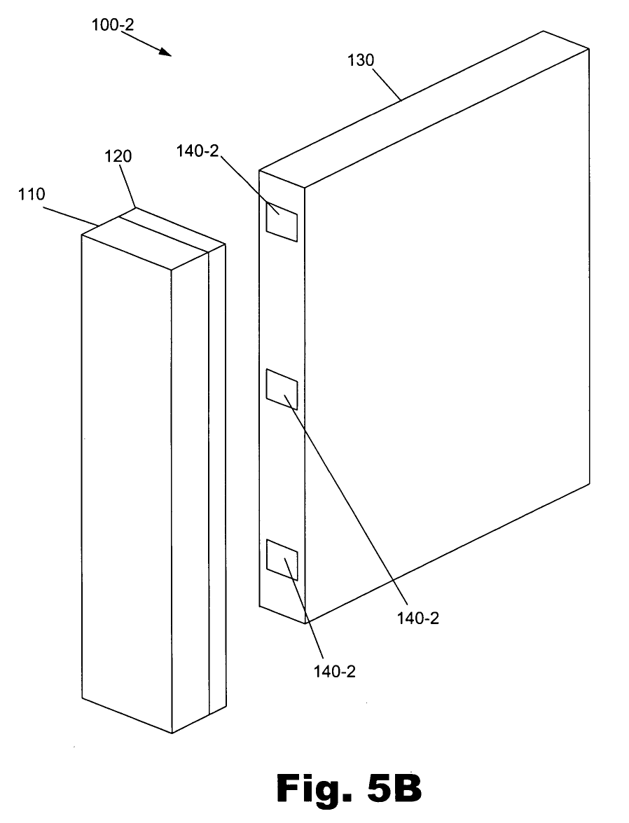

FIG. 6 is a perspective view of an exemplary anti-rattle device (140). The anti-rattle device can comprise a base (610), and a pair of friction members (620) extending from the base (610). As shown in FIG. 6, the base (610) can include connection apertures (630) useful for securing the anti-rattle device (140) to the doorjamb (120) as shown in FIG. 1.

The anti-rattle device (140) can be made of a number of different materials, including but not limited to metal and plastic materials. In a preferred embodiment, the anti-rattle device (140) comprises a malleable material such as a type of metal. This allows the anti-rattle device (140) to be adjusted by being bent to fit various sizes of pocket doors (130). The adjustability of the anti-rattle device (140) will be discussed below.

The base (610) should comprise a mechanism for connecting to the doorjamb (120) or the wall (110). As shown in FIG. 6, the base (610) can include a number of connection apertures (630). In a preferred embodiment, the connection apertures (630) comprise screw holes. Accordingly, the anti-rattle device (140) can be secured to the door jamb (120) or the wall (110).

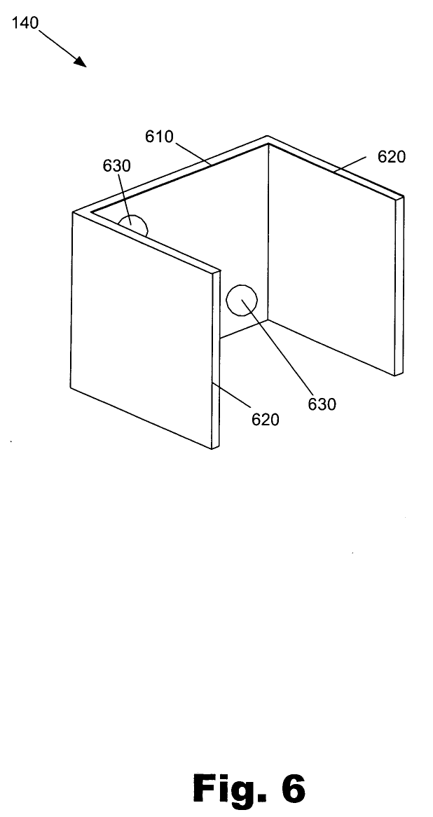

The base (610) should comprise a size that helps the anti-rattle device (140) fittingly receive and secure the pocket door (130). For example, FIG. 7 is a top-view of the anti-rattle device (140) of FIG. 6. As shown in FIG. 7, the length of the base (610) can be a predetermined distance (D) that corresponds approximately with a width of a pocket door (130). Preferably, the predetermined distance (D) is approximately the same as or slightly greater than the width of the pocket door (130).

By being an appropriate size, the base (610) can separate the friction members (620) apart from one another by an appropriate distance (D) for fittingly receiving the pocket door (130). As shown in FIG. 6, the friction members (620) can comprise a pair of oppositely oriented friction members (620) extending away from the base (610). The friction members (620) can extend away from opposite edges of the base (610).

The friction members (620) should be configured to minimize movements of the pocket door (130) that can create rattle noise. For example, the friction members (620) may include a material helpful for providing friction with the pocket door (130). The friction members (620) may include a friction inducing material, including but not limited to perforated rubber or felt. The friction inducing material can be applied as a pad on the friction members (620). Further, the material can provide cushioning helpful for preventing wear and tear on the pocket door (130).

The friction members (620) should be positioned to snugly house the received pocket door (130). For example, the friction members (620) can be distanced apart from each other by the predetermined distance (D) discussed above in relation to the size of the base (610). In an exemplary embodiment, the edges of the friction members (620) are tapered for guiding the pocket door (130) into a fittingly received position.

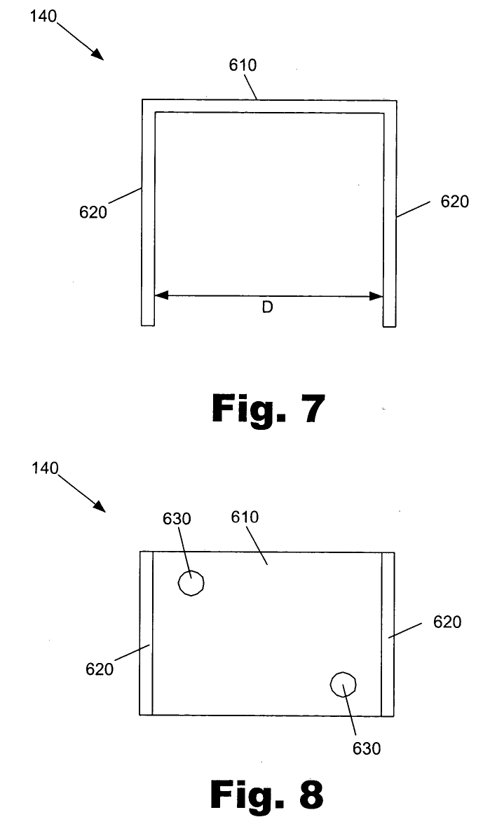

Further, the friction members (620) can be adjustable. This allows the anti-rattle device (140) to be adjusted by bending the friction members (620) toward or apart from one another to fit a particular pocket door (130). For example, the anti-rattle device (140) can be bent into a general “U-shape” of a size appropriate for fittingly receiving a particular pocket door (130), such as the “U-shape” shown in FIG. 7. FIG. 8 shows a front-view of the same anti-rattle device (140).

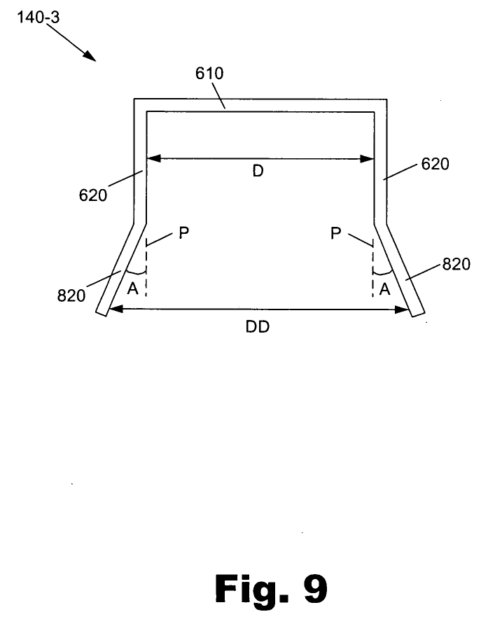

FIG. 9 is a top-view of an exemplary anti-rattle device (140-3) having guide members (920). The guide members (920) should be configured to help guide the pocket door (130) toward the friction members (620). As shown in FIG. 9, the guide members (920) can be coupled to and extend away from the friction members (620). Preferably, each of the guide members (920) extends away from each friction member (620) at a predefined angle (A) relative to a plane (P) defined by the friction member (620), such that the guide members (920) are distanced farther apart than the friction members (620). In other words, a distance (DD) between the guide members (920) should be greater than the predefined distance (D) between the friction members (620). The sloping guide members (920) can then receive and guide the pocket door (130) towards reception by the friction members (620). While the guide members (920) provide useful functions, many embodiments of the anti-rattle device (140) can function to fittingly receive the pocket door (130) without having the guide members (920).

Exemplary Installation Process

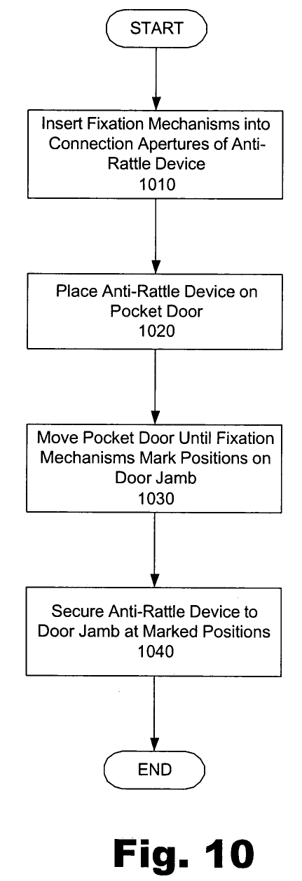

FIG. 10 is a flow diagram of an exemplary process for installing the anti-rattle devices (140; FIG. 1) in the pocket door assembly (100; FIG. 1). At step 1010, fixation mechanisms can be inserted into the connection apertures (630; FIG. 6) of the anti-rattle device (140; FIG. 1). In a preferred embodiment, the fixation mechanisms comprise screws. However, the fixation mechanisms may be any members for attaching the anti-rattle device, including, but not limited to, nails, tacks, screws, staples and the like. At step 1020, the anti-rattle device (140; FIG. 1) can be placed on the pocket door (130; FIG. 1). For placement on the pocket door (130; FIG. 1), the anti-rattle device (140; FIG. 1) may be adjusted to fit. At step 1030, the pocket door (130; FIG. 1) is moved until the fixation mechanisms mark positions on the door jamb (120; FIG. 1). For example, the screws can make indentations on the door jamb (120; FIG. 1). At step 1040, the anti-rattle device (140; FIG. 1) can be secured to the door jamb (120; FIG. 1) at the marked positions. This process can be used to determine an appropriate position for the anti-rattle device (140; FIG. 1), at which position, the anti-rattle device (140; FIG. 1) should be located to fittingly receive the pocket door (130; FIG. 1). The process can be repeated to install any number of anti-rattle devices (140; FIG. 1) in the pocket door assembly (100; FIG. 1).

The preceding description has been presented only to illustrate and describe the present assemblies, devices, and methods. It is not intended to be exhaustive or to limit the present assemblies, devices, or methods to any precise form or application disclosed. Many modifications and variations are possible in light of the above teachings. It is intended that the scope of the assemblies, devices, and methods be defined by the following claims.

1. A pocket door assembly, comprising:
a door jamb configured to stop a pocket door at a closed position; and
at least one anti-rattle device coupled to said doorjamb, wherein said anti-rattle device is configured to fittingly receive said pocket door at said closed position.

2. The pocket door assembly of claim 1, wherein said anti-rattle device comprises:
a base coupled to said door jamb; and
a pair of oppositely oriented friction members extending from opposite edges of said base, wherein said friction members are separated from each other by a predefined distance such that said friction members are configured to fittingly receive said pocket door.

3. The pocket door assembly of claim 2, wherein said friction members are adjustable.

4. The pocket door assembly of claim 2, wherein said anti-rattle device further comprises a pair of oppositely oriented guide members extending from said pair of friction members such that said guide members are configured to guide said pocket door for reception by said friction members.

5. The pocket door assembly of claim 4, wherein each said guide member extends away from said each said friction member at an angle relative to a plane of said friction member such that a distance between said pair of oppositely oriented guide members is greater than said predefined distance between said pair of friction members.

6. The anti-rattle device of claim 2, wherein said base includes at least two connection apertures configured to receive fixation mechanisms for securing said base to said door jamb.

7. The pocket door assembly of claim 1, wherein said anti-rattle device comprises:
a pair of oppositely positioned friction ledges connected to and protruding from said door jamb, wherein said friction ledges are separated from each other by a predefined distance such that said friction ledges are configured to fittingly receive said pocket door.

8. The pocket door assembly of claim 7, wherein said friction ledges are tapered to guide said pocket door.

9. A pocket door assembly, comprising:
at least one anti-rattle device positioned at a back region of a wall pocket, wherein said anti-rattle device is configured to fittingly receive a pocket door at an open position.

10. The pocket door assembly of claim 9, wherein said anti-rattle device comprises:
a base coupled to said back region of said wall pocket; and
a pair of oppositely oriented friction members extending from opposite edges of said base, wherein said friction members are separated from each other by a predefined distance such that said friction members are configured to fittingly receive said pocket door.

11. The pocket door assembly of claim 10, wherein said friction members are adjustable.

12. The pocket door assembly of claim 10, wherein said anti-rattle device further comprises a pair of oppositely oriented guide members extending from said pair of friction members such that said guide members are configured to guide said pocket door for reception by said friction members.

13. The pocket door assembly of claim 12, wherein each said guide member extends away from said each said friction member at an angle relative to a plane of said friction member such that a distance between said pair of oppositely oriented guide members is greater than said predefined distance between said pair of friction members.

14. The anti-rattle device of claim 10, wherein said base includes at least two connection apertures configured to receive fixation mechanisms for securing said base to said back region of said wall pocket.

15. The pocket door assembly of claim 9, wherein said anti-rattle device comprises:
a pair of oppositely positioned friction ledges connected to and protruding from said back region, wherein said friction ledges are separated from each other by a predefined distance such that said friction ledges are configured to fittingly receive said pocket door.

16. The pocket door assembly of claim 15, wherein said friction ledges are tapered to guide said pocket door.

17. A pocket door assembly, comprising:
a pocket door;
a door jamb configured to stop said pocket door at a closed position;
a first anti-rattle device coupled to said door jamb; and
a second anti-rattle device coupled to said pocket door opposite from said first anti-rattle device, wherein said first anti-rattle device and said second anti-rattle device are configured to couple together when said pocket door is at the closed position.

18. The pocket door assembly of claim 17, wherein said first anti-rattle device and said second anti-rattle device comprise magnets.

19. The pocket door assembly of claim 17, wherein said first anti-rattle device comprises a first magnet adhesively coupled to said door jamb, and said second anti-rattle device comprises a second magnet adhesively coupled to said pocket door.

20. A pocket door assembly, comprising:
a pocket door comprising a magnetic material;
a door jamb configured to stop said pocket door at a closed position;
at least one magnetic anti-rattle device coupled to said door jamb, wherein said at least one magnetic anti-rattle device is configured to couple to said pocket door when said pocket door is at the closed position.

21. The pocket door assembly of claim 20, wherein said at least one magnetic anti-rattle device is adhesively coupled to said door jamb.

22. A method of installing an anti-rattle device on a doorjamb of a pocket door assembly, comprising:
inserting fixation mechanisms into connection apertures of said anti-rattle device;
placing said anti-rattle device fittingly on a pocket door of said pocket door assembly;
moving said pocket door until said fixation mechanisms mark positions on said door jamb; and
securing said anti-rattle device to said doorjamb at said marked positions.

23. The method of claim 22, further comprising bending said anti-rattle device to fit said pocket door.

24. The method of claim 22, wherein said fixation mechanisms comprise screws.

25. The method of claim 22, wherein said marked positions comprise indentations in said door jamb.
